(19) United States
(12) Patent Application Publication
(10) Pub. No.: US 2024/0394914 A1
(43) Pub. Date: Nov. 28, 2024

(54) VEHICLE SHAPE AND POSE DETERMINATION FOR VEHICLE APPLICATIONS

(71) Applicant: QUALCOMM Incorporated, San Diego, CA (US)

(72) Inventors: Jeong-Kyun Lee, Seoul (KR); Young-Ki Baik, Namyangju-si (KR); Yongho Shin, Seoul (KR); Sueyeon Kim, Bundang-gu (KR); Duck Hoon Kim, Seoul (KR)

(21) Appl. No.: 18/321,616

(22) Filed: May 22, 2023

(51) Int. Cl. G06T 7/73; G06T 7/13; G06T 7/564

(52) U.S. Cl. CPC G06T 7/74; G06T 7/13; G06T 7/564; G06T 2207/20081; G06T 2207/30261

(57) ABSTRACT

This disclosure provides systems, methods, and devices for vehicle driving assistance systems that support image processing. In a first aspect, a method includes receiving images of a vehicle and determining locations of key points of the vehicle within the keyframes. Pose estimations may then be determined based on the key point locations, and a three-dimensional contour of the vehicle may be determined based on the pose estimations. A model may then be trained based on the three-dimensional contour of the vehicle. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect includes a method that includes receiving a first plurality of images of a vehicle. The method also includes determining key point locations within keyframes selected from the first plurality of images. The method also includes determining pose estimations for the vehicle based on the key point locations within the keyframes. The method also includes determining a three-dimensional contour of the vehicle based on the pose estimations. The method also includes training a first machine learning model based on the three-dimensional contour of the vehicle.

Another aspect includes an apparatus that a memory storing processor-readable code and at least one processor coupled to the memory. The at least one processor may be configured to execute the processor-readable code to cause the at least one processor to perform operations that include receiving a first plurality of images of a vehicle. The operations also include determining key point locations within keyframes selected from the first plurality of images. The operations also include determining pose estimations for the vehicle based on the key point locations within the keyframes. The operations also include determining a three-dimensional contour of the vehicle based on the pose estimations. The operations also include training a first machine learning model based on the three-dimensional contour of the vehicle.

Another aspect includes a non-transitory computer-readable medium storing instructions that, when executed by a processor, cause the processor to perform operations that include receiving a first plurality of images of a vehicle. The operations also include determining key point locations within keyframes selected from the first plurality of images. The operations also include determining pose estimations for the vehicle based on the key point locations within the keyframes. The operations also include determining a three-dimensional contour of the vehicle based on the pose estimations. The operations also include training a first machine learning model based on the three-dimensional contour of the vehicle.

Another aspect includes a vehicle that includes a memory storing processor-readable code and at least one processor coupled to the memory. The at least one processor may be configured to execute the processor-readable code to cause the at least one processor to perform operations that include receiving a first plurality of images of a vehicle. The operations also include determining key point locations within keyframes selected from the first plurality of images. The operations also include determining pose estimations for the vehicle based on the key point locations within the keyframes. The operations also include determining a three-dimensional contour of the vehicle based on the pose estimations. The operations also include training a first machine learning model based on the three-dimensional contour of the vehicle.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram of a system for vehicle shape and pose determination according to one or more aspects of the disclosure.

FIG. 5A depicts an image capture scenario according to an exemplary embodiment of the present disclosure.

FIG. 5B depicts key point definitions according to exemplary embodiments of the present disclosure.

FIG. 5C depicts an image processing scenario according to an exemplary embodiment of the present disclosure.

FIG. 6 is a flow chart illustrating an example method for vehicle shape and pose determination according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support vehicle shape and pose determination. Pose determination, or pose estimation, may include computer vision techniques to detect and track the position and orientation of objects or people in an image or video. For vehicle applications, pose determination may be used to detect and determine positions and orientations of objects, people, other vehicles, and the like within an area surrounding a particular vehicle (such as for use in controlling the vehicle or otherwise monitoring the area surrounding the vehicle). In particular, machine learning models, such as deep learning models, may be essential for autonomous driving (such as to determine the positions and trajectories of nearby vehicles). Such models require a lot of annotated data, such as vehicle shape, pose, position, and the like. Ground truth annotation may be used to initially generate training data, such as by using other deep learning models trained on annotation data. However, annotating three-dimensional information (such as the location and size of a car in a real-world 3D cartesian coordinate system) may be challenging. Furthermore, inaccurate training data decreases the quality of training for a model, thereby increasing the computing resources consumed to accurately train the model and further increasing the amount of training data required to train the model.

One solution to this problem is to predict three-dimensional contours of vehicles based on multiple images captured of the vehicles (such as multiple images captured from different viewing angles). The three-dimensional contours may be determined by first determining locations of particular key points of the vehicle (such as one or more predefined portions or features of the vehicle) within the images. The key point locations may then be used to determine pose estimations of the vehicle within the key frames. The pose estimations may then be used (such as combined) to form the three-dimensional contour of the vehicle. The three-dimensional contour may then be used to annotate training data for another machine learning model. For example, the three-dimensional contour may be used to determine three-dimensional position information that serves as ground truth values for training the machine learning model.

Particular implementations of the subject matter described in this disclosure may be implemented to realize one or more of the following potential advantages or benefits. In some aspects, the present disclosure provides techniques for image processing that may be particularly beneficial in smart vehicle applications. For example, compared to conventional ground truth techniques, these techniques may be able to determine tighter vehicle boundaries (such as more precise three-dimensional contours of vehicles) when compared to three-dimensional bounding boxes, enabling greater determination of the positions of nearby vehicles. For example, in certain implementations, accurate and tight three-dimensional contours may be generated based on an active shape model (ASM). Furthermore, the pose estimations may enable more accurate yaw (orientation) information for depicted vehicles. Furthermore, by using the three-dimensional contour to determine the three-dimensional position information for the training data, these techniques may enable accurate full 3D results even for truncated and occluded vehicles within images. Additionally or alternatively, it may be possible to annotate distorted images using these techniques. Also, by improving the quality of training data made available to the machine learning model, these techniques may reduce the computing resources necessary to train the machine learning model and may reduce the overall amount of training data required to train the machine learning model. Furthermore, such techniques may increase the amount of available training data for such models by reducing the amount of manual annotation of training data that is required. Stated differently, the present disclosure describes techniques that can be used to generate ground truth data (such as training data) for machine learning models automatically (such as without human annotation) or semi-automatically (such as with little human intervention). As a result, these techniques can greatly increase available training data while minimizing human resources and costs, which may have the effect of improving the quality and accuracy of results generated by machine learning models trained using the larger training data sets.

One major benefit of improved vehicle tracking is that it allows vehicle control systems to more accurately navigate vehicles around obstacles. This can be particularly useful in situations where there may be unexpected obstructions or road conditions that could pose a hazard to drivers. Additionally, improved tracking can help to improve overall safety on the roads by reducing vehicle collisions. With better tracking capabilities, vehicles can be made more responsive to nearby obstacles and can be routed around detected obstacles more efficiently. These improvements can also extend to driver assistance systems, which can benefit from increased monitoring capabilities. By expanding the number, type, and variety of surrounding vehicles that can be detected, these systems can offer more accurate alerts and assistance to drivers when necessary, without generating unnecessary notifications or distractions.

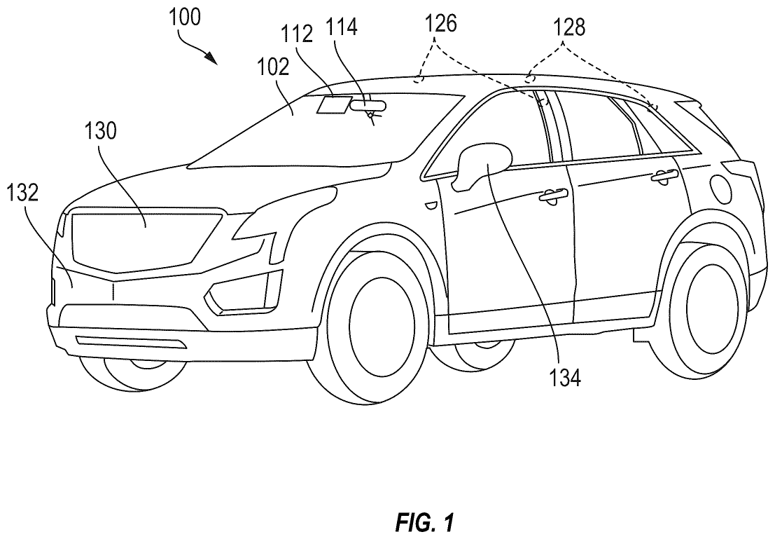

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or in a forward direction. In some embodiments, an additional camera may be located at the rear of the vehicle 100 and oriented such that the field of view of the additional camera captures a scene behind the vehicle 100 in the direction that the vehicle 100 is moving when in reverse mode or in a reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the vehicle 100 is traveling in a forward direction may likewise be obtained while the vehicle 100 is traveling in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

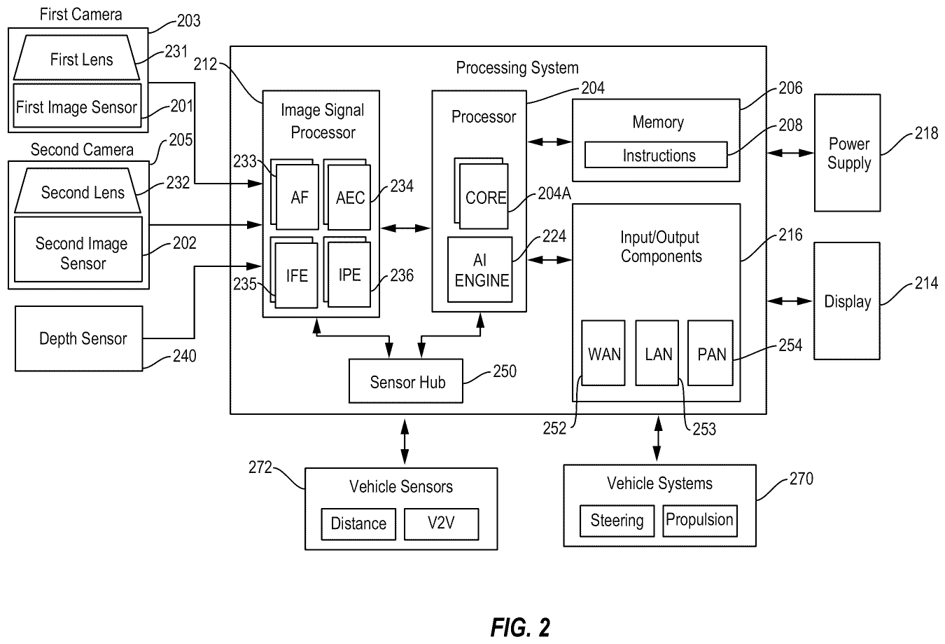

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. The memory 206 may also be accessed (such as by the image signal process 212, by the processor 204, or combinations thereof) to store points and/or contours of vehicles located in a surrounding environment. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. As another example, execution of the instructions can instruct the processor 204 to determine locations of points (such as key points) for nearby vehicles based on image data received from the cameras 203, 206 and to determine three-dimensional contours of the vehicles based on those locations. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

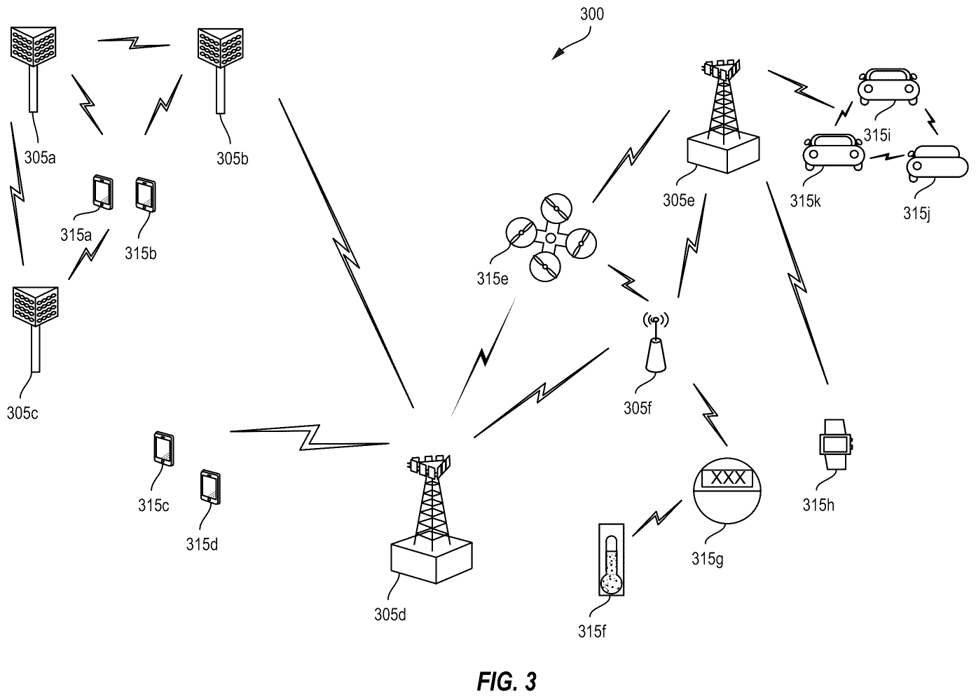

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (CNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315c-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305c.

Aspects of the vehicular systems described with reference to, and shown in, FIG. 1, FIG. 2, and FIG. 3 may include vehicle shape and pose determination, such as for use in one or more processing, awareness, or control systems of a vehicle.

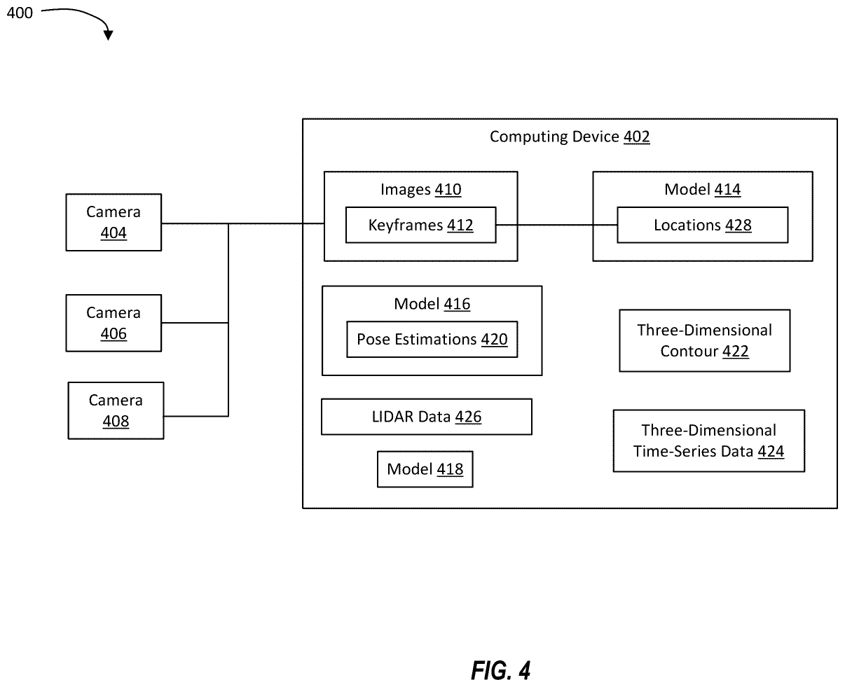

FIG. 4 is a block diagram illustrating a system 400 for vehicle shape and pose determination according to an exemplary embodiment of the present disclosure. The system 400 includes a computing device 402 and cameras 404, 406, 408. The computing device 402 includes a first plurality of images 410, models 414, 416, 418, LIDAR data 426, a three-dimensional contour 422, and three-dimensional time-series data 424. The first plurality of images 410 includes keyframes 412. The model 414 includes locations 428 and the model 416 includes pose estimations 420. The system 400 may be an exemplary implementation of one or more above-discussed aspects. For example, the system 400 may be contained within the vehicle 100, may be an exemplary implementation of the processing system if FIG. 2 (such as the ISP 212, the processor 204, or combinations thereof), and the like.

The computing device 402 may be configured to receive images of a vehicle and to estimate or otherwise determine a shape of the vehicle and poses of the vehicle within at least a subset of the images. In particular, the computing device 402 may be configured to receive a first plurality of images 410 of a vehicle. The images 410 may be captured by one or more image sensors, such as one or more of the cameras 404, 406, 408. In certain implementations, the images 410 may be captured from image sensors located on a second vehicle, such as another vehicle adjacent to or otherwise within visual range of the depicted vehicle on a roadway. In such implementations, the cameras 404, 406, 408 may face different directions on the second vehicle.

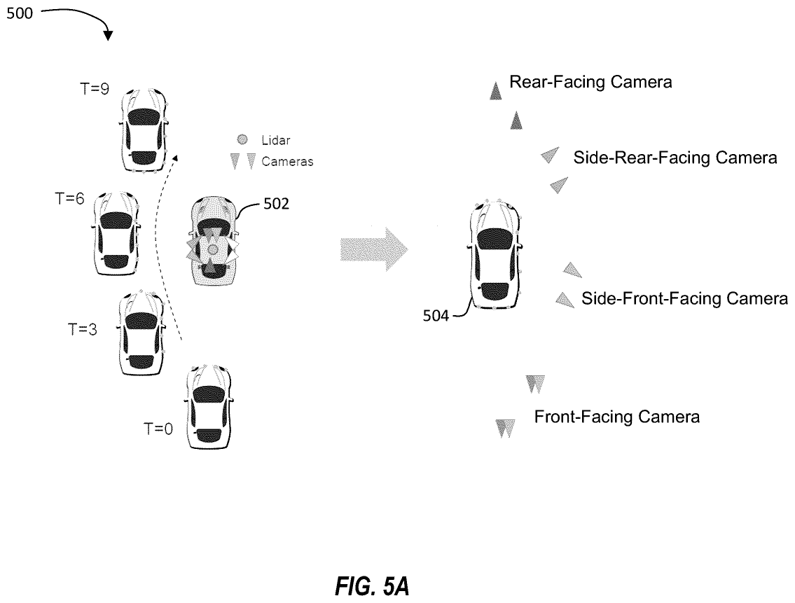

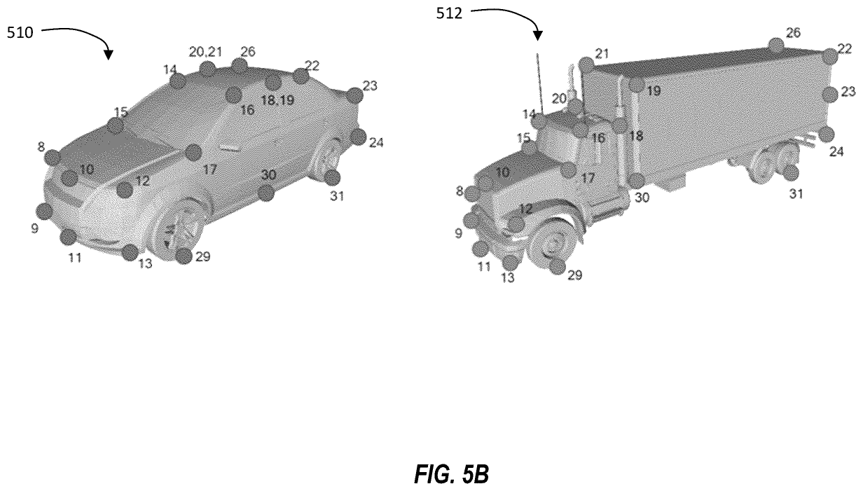

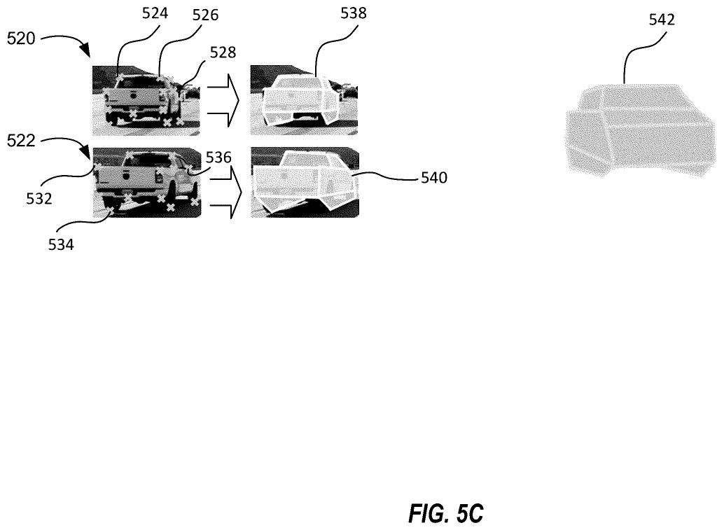

In certain implementations, the plurality of images 410 of the vehicle may include multiple views of the vehicle captured from multiple angles. Multiple views may include images captured from multiple angles relative to the depicted vehicle. In certain implementations, at least a subset of the multiple views are captured at different times by the same camera (such as a first camera of the plurality of cameras 404, 406, 408 that captured the first plurality of images 410). For example, FIG. 5A depicts an image capture scenario 500 according to an exemplary embodiment of the present disclosure. In the scenario 500, images of a first vehicle 504 are captured by cameras mounted on a second vehicle 502. The cameras face different directions on the first vehicle 502. For example, the first vehicle 502 includes one rear-facing camera, two front-facing cameras, two side-rear-facing cameras (one left and one right), and two side-front-facing cameras (one left and one right). In the scenario 500, the first vehicle 504 drives past the second vehicle 502 and is accordingly located at different positions relative to the second vehicle 502 at different times (T=0, 3, 6, 9). As the first vehicle 504 drives past the second vehicle 502, the first vehicle 504 is located in the field of view of different cameras, which capture different views of the vehicle (such as images from different poses and different portions of the first vehicle 504). In particular, as shown on the right side of FIG. 5A, images are captured by the rear-facing camera, front-facing camera, one side-rear-facing camera (on the left side) and one side-front-facing camera (on the left side). Accordingly, the cameras are able to capture multiple images from multiple view of the vehicle 504.

Returning to FIG. 4, in certain implementations, the first plurality of images 410 may be a sequence of images captured by the one or more cameras 404, 406, 408. For example, the camera may record a video or otherwise capture images at a regular frequency (such as 60 frames per second (FPS), 30 FPS, 24 FPS, 10 FPS, 5 FPS, and the like). In further implementations, the images 410 may be captured by multiple cameras located on multiple vehicles (such as multiple vehicles located near the depicted vehicle on the roadway). In certain implementations, the multiple views of the vehicle may include at least two views captured by two cameras with overlapping fields of view. For example, in FIG. 5A, the side-rear-facing camera and the side-front-facing camera may have overlapping fields of view. In additional or alternative implementations, one or more of the cameras may not have overlapping fields of view with any of the other cameras.

In certain implementations, the first plurality of images 410 of a vehicle are selected based on a cross-correlation of a second plurality of images captured by the multiple cameras 404, 406, 408 to identify the first plurality of images 410 that contain depictions of the vehicle. For example, the cameras 404, 406, 408 may capture many images of multiple vehicles. To identify the first plurality of images 410, the computing device 402 may perform a cross-correlation between images within the second plurality of images to identify which images depict the same vehicle(s). For example, the computing device 402 may perform intersection over union (IOU) cross-correlation and association of the images within the second plurality of images to identify which images depict the same vehicle. The first plurality of images 410 may then be identified as a subset of the second plurality of images that depict the same vehicle (such as a desired vehicle). In certain implementations, the second plurality of images may be stored in association with identifiers of vehicles depicted within each of at least a subset of the second plurality of images, and the first plurality of images 410 may be identified as images with the same corresponding identifier.

The computing device 402 may be configured to determine key point locations 428 within keyframes 412 selected from the first plurality of images 410. In certain implementations, prior to determining the key point locations 428, the computing device 402 may determine the keyframes 412 as a subset of the first plurality of images 410 of the vehicle (e.g., a subset of frames captured by the cameras 404, 406, 408). The keyframes 412 may be identified based on positions of the vehicle within the subset of the first plurality of images 410. For example, the keyframes 412 may be identified as images from the first plurality of images 410 in which the vehicle is located within a center portion of the image. In certain implementations, the center portion of an image may be a region located within a predetermined threshold distances from a center coordinate of the image (5%, 10%, 25%, 33%, 50%). In certain implementations, the computing device 402 may determine a position of the vehicle within an image (such as the position of the center of the vehicle, the center of a bounding box surrounding the depicted vehicle, and the like). If the position of the vehicle is located within the center portion of the image, the image may be identified as a keyframe or a candidate keyframe. In additional or alternative implementations, keyframes 412 may be identified as images in which the vehicle is more than a predetermined size. For example, the computing device 402 may determine a size of a bounding box surrounding the vehicle within an image and may determine that the image is a keyframe or candidate keyframe if the bounding box is more than a threshold percentage of image area (such as 20% of the image area, 40% of the image area, 50% of the image area, and the like). In still further implementations, the computing device 402 may automatically select stable frames from among the first plurality of images 410 to include images with different views and to include a limited number of keyframes from each camera. For example, the computing device may select 4 keyframes per camera after sorting frames by the bounding box size and position of the vehicle.

Locations 428 of key points within the keyframes 412 may then be determined. In certain implementations, the key point locations 428 are locations of predefined vehicle features within the keyframes 412. In certain implementations, the predefined vehicle features may include one or more spatial features representative of a particular object or portion of the vehicle (such as parts of a door, tailgate, windshield, quarter panel, wheel, antenna, grill, headlight, taillight, and the like). For example, FIG. 5B depicts key point definitions 510, 512 according to exemplary embodiments of the present disclosure. In particular, the key point definition 510 identifies key points 8-31 for a sedan type vehicle and the key point definition 512 identifies key points 8-31 for a truck type vehicle. In certain implementations, different key point locations 428 may be used for different types of vehicles. For example, the computing device 402 may maintain separate key point definitions 510, 512 for different types of vehicle. Returning to FIG. 4, in such instances, the computing device 402 may determine a type of vehicle depicted within the first plurality of images 410. In certain implementations, the vehicle may be predetermined and an indication of the type of vehicle may be received with the first plurality of images 410. In additional or alternative implementations, the computing device 402 itself may determine the type of vehicle (such as using a classifier model or similar techniques). The computing device 402 may then select the key points for which locations 428 are determined based on the determined type of vehicle.

In certain implementations, the key point locations 428 may be determined as a vector perpendicular to the surface of the vehicle at the locations 428 of the predefined vehicle features defined by the key points. For example, each key point location 428 may be determined as two-dimensional coordinates within an image, three-dimensional spatial coordinates, or combinations thereof. In certain implementations, the key point locations 428 may in this way approximate a three-dimensional contour 422 of the vehicle with greater detail than a bounding box (such as by allowing for curvature and other features for surfaces connecting the points). In certain implementations, the key point locations 428 are determined using a machine learning model, such as the model 414. In particular, the model 414 may receive the keyframes 412 and may be trained to identify locations 428 of one or more key points visible within the keyframes 412. In certain implementations, the model 414 may be implemented as a neural network in combination with one or more deconvolution layers.

The computing device 402 may be configured to determine pose estimations 420 for the vehicle based on the key point locations 428 within the keyframes 412. In certain implementations, the pose estimations 420 may reflect an estimated shape and orientation of the vehicle relative to a camera 404, 406, 408 that captured the keyframe. For example, the pose estimations 420 may be 6-dimensional representations of the positional coordinates (such as x, y, and z coordinates forming a translational vector) and orientations (such as pitch, yaw, and roll orientations forming an orientation vector) of the vehicle. In certain implementations, the pose estimations 420 may be determined by connecting the key point locations 428 to form an approximated shape of the vehicle. For example, pose estimations 420 may be determined utilizing perspective-N-Point processes. For example, FIG. 5C depicts images 520, 522 with corresponding key point locations 524, 526, 528, 532, 534, 536 identified. The key point locations may then be connected to form the pose estimations 538, 540 for the images 520, 522. In certain implementations, the pose estimations 538, 540 may additionally contain three-dimensional spatial information representative of the relative orientation of the vehicle. For example, the portions of the pose estimations 538, 540 near the front of the vehicle may indicate a greater depth (such as a greater distance from a camera that captured the images 520, 522) than portions of the pose estimations 538, 540 near the rear of the vehicle.

The computing device 402 may be configured to determine a three-dimensional contour 422 of the vehicle based on the pose estimations 420. In certain implementations, the three-dimensional contour 422 of the vehicle may be determined as a weighted combination of vectors defining different three-dimensional contours, such as vehicle shape base vectors. For example, in FIG. 5C, a three-dimensional contour 542 may be determined based on the pose estimations 538, 540. In particular, the three-dimensional contour 422 of the vehicle may be determined according to an active shape model (ASM) system for defining three-dimensional shapes. In particular, the ASM may express shapes as a weighted combination of multiple predefined shapes (such as predefined contours of different types of vehicles, also known as vehicle shape base vectors). In certain implementations, the vehicle shape base vectors may be represented as combinations of key point locations (such as a combination of three-dimensional vectors perpendicular to the predefined vehicle shapes at the key points). In such instances, determining the three-dimensional contour 422 of the vehicle may include determining weights for each of at least a subset of the predefined shapes such that, when key points from the predefined shapes are combined according to the weights, the resulting combined shape represents the three-dimensional contour. For example, the three-dimensional contour 422 may be expressed as:

$$s = {s}_{0} + {\sum }_{i = 1}^{N} {λ}_{i} {s}_{i} ,$$

where:
s is the three-dimensional contour 422, which may be represented as a combination of vectors (such as according to an ASM representation),
s₀ is a mean vector defining a mean three-dimensional contour (such as a mean contour for the determined vehicle type),
sᵢ is a base vector defining a deviation from so, which may be calculated using principal component analysis that computes principal components to efficiently represent data by a weighted combination of components,
λᵢ is the weight for the i-th base vector, and
N is the number of base vectors.

In certain implementations, weights corresponding to the pose estimations 420 are determined according to one or more cost functions. In certain implementations, the weights are determined to minimize reprojection errors between the keyframes and reprojected key points generated based on the three-dimensional contour 422. In certain implementations, the three-dimensional contour 422 may be used to determine reprojected locations within of key points within at least a subset of the keyframes. For example, the reprojected locations may be determined based on location of the key points on the three-dimensional contour 422 and the relative position of the vehicle in the keyframe (such as orientation and distance relative to a camera 404, 406, 408 that captured the keyframe image). In certain implementations, a cost function to minimize reprojection errors may be formulated as:

$${C}_{cam} ( ξ , λ , s ) = {\sum }_{i = 1}^{3} {\sum }_{j = 1}^{{n}_{i}} {‖ π ( {T}_{{c}_{i}} T ( ξ ) [ \begin{matrix}s ( {X}_{j}^{m} + {\sum }_{k} {λ}_{k} {X}_{j , k}^{b} ) \\ 1\end{matrix} ] ) - {x}_{j} ‖}^{2}$$

where:
   C_{cam} is the cost function to minimize reprojection errors,
   i is summed over the number of cameras (such as 3 in the depicted example),
   nᵢ is the number of inlier key points (such as visible key points) for images captured by the i-th camera,
   Xⱼ^{m} is the mean vector of the ASM representation of the j-th key point three-dimensional contour 422, which may be represented as s₀ when computing the three-dimensional contour 422,
   X_{j,k}^{b} is the k-th base vector of the j-th key point in the ASM representation of the three-dimensional contour 422,
   Δₖ is the k-th weight for the base vector,
   ξ is a vector containing the pose estimations 420,
   xⱼ is the key point location of the j-th key point within the keyframe (such as an annotated two-dimensional key point location serving as ground truth),
   π is a camera projection function,
   T_{c}_{ᵢ} is an extrinsic camera parameter to transform coordinates within images captured by the i-th camera to three-dimensional position coordinates, and
   T(ξ) is a transformation matrix determined based on the pose estimations 420

In additional or alternative implementations, the weights and/or an orientation vector of the final three-dimensional contour may be determined to minimize differences between positions of key points within the three-dimensional contour 422 and corresponding positional measurements for the keyframes 412. For example, the weights may be determined based on measured positions of key points captured with the images 410. For example, the computing device 402 may receive LIDAR data 426 that was captured at the same time as the images 410 (such as using one or more LIDAR sensors located on the same vehicle as the cameras 404, 406, 408). In such instances, positions for the key points within the LIDAR data 426 may be compared to key point locations for the keyframes 412 to determine the weights for the pose estimation 420. In certain implementations, the computing device 402 may determine virtual points on a surface of vehicle from the contour based on positions of the key points and minimize the distance between the points from the LIDAR data 426 and the virtual points to determine the weights. In certain implementations, a cost function to minimize measured positional differences may be formulated as:

$${C}_{lidar} ( ξ , λ , s ) = {\sum }_{i} {‖ {\hat{X}}_{i} - sR ( {X}_{i}^{m} + {\sum }_{j} {λ}_{j} {X}_{i , j}^{b} ) - t ‖}^{2}$$

where:
   C_{lidar} is the cost function to minimize measured positional differences,
   i is summed over all measured positions corresponding to vehicle key points,
   \hat{X}ᵢ is the i-th range observation from the LIDAR data 426,
   Xᵢ^{m} is a weighted sum of the vertices of the mean vector of the ASM representation of the three-dimensional contour 422,
   X_{i,j}^{b} is a weighted sum of the vertices of the base vector of the ASM representation of the three-dimensional contour 422,
   t is a translation vector for the pose estimations 420 (such as a component of ξ),
   R is a rotation matrix for the pose estimations 420 (such as a rotation matrix determined base on ω, an orientation vector of ξ), and
   s is a scaling factor (which may have a default value of 1 and may vary according to a size of the vehicle.

It should be understood that the LIDAR data 426 is merely an exemplary implementation of positional data that may be received by the computing device 402 in order to determine weights for the three-dimensional contour 422. In additional or alternative implementations, the positional data may be measured by other types of positional sensors, such as ultrasonic positional sensors, stereo imaging sensors, and the like. In various implementations, the use of positional data such as LIDAR data 426 may improve the accuracy of depth, distance, and position observations relative to implementations that rely only on image data.

In certain implementations, weights may be determined based on multiple cost functions. For example, a weighted combination of multiple cost functions may be used to determine the weights. As a specific example, a cost function may be used that provides a weighted combination of the C_{cam} and C_{lidar} functions above, such as:

$${C}_{total} = {w}_{cam} {C}_{cam} + {w}_{lidar} {C}_{lidar} ,$$

where:
   Cₜₒₜₐₗ is the combined cost function,
   w_{cam} is the weight for the C_{cam} cost function, and
   w_{lidar} is the weight for the C_{lidar} cost function.

In certain implementations, weights for the cost functions may be predetermined. In additional or alternative implementations, the computing device may be configured to determined one or more of the weights. In additional or alternative implementations, the computing device may be configured to select between and combine various cost functions (such as by adjusting one or more weights associated with thee cost functions).

In certain implementations, prior to determining the pose estimations 420, the computing device 402 may be configured to receive, via a user-interface, one or more corrected key point locations. For example, a user interface may present a representation of one or more of the keyframes 412 with locations of key points overlaid, similar to the representation of the images 520, 522 within the FIG. 5C. In such implementations, a user may adjust one or more key point locations (such as by clicking and dragging the key point to reposition it). The corrected key point locations may then be received from the user. In such instances, the computing device may determine the pose estimations 420 based on the corrected key point locations. In certain implementations, a model 414 configured to determine the locations 428 may be updated based on the corrected key point locations. For example, the model 414 may be trained based on training data to determine the locations 428. In such instances, the corrected key point locations may be added to training data for the model 414 (such as in association with corresponding keyframes). As a specific example, the training data sets may specify one or more expected outputs, and the corrected key point locations may represent expected outputs for the corresponding images. Parameters of the model 414 may be updated based on whether the model 414 generates correct outputs when compared to the expected outputs. In particular, the model 414 may receive one or more pieces of input data from the training data sets that are associated with a plurality of expected outputs. The model 414 may generate predicted outputs based on a current configuration of the model 414. The predicted outputs may be compared to the expected outputs and one or more parameter updates may be computed based on differences between the predicted outputs and the expected outputs. In particular, the parameters may include weights (e.g., priorities) for different features and combinations of features. The parameter updates to the model 414 may include updating one or more of the features analyzed and/or the weights assigned to different features or combinations of features (e.g., relative to the current configuration of the model 414).

The computing device 402 may be configured to train a first machine learning model 418 based on the three-dimensional contour 422 of the vehicle. In certain implementations, prior to training the first machine learning model 418, the computing device may determine three-dimensional time-series data 424 comprising three-dimensional position information for the vehicle within at least a subset of the first plurality of images 410 of the vehicle. In such instances, training the first machine learning model 418 may include training the first machine learning model 418 based on the three-dimensional position information within at least the subset of the first plurality of images 410. In certain implementations, at least the subset the first plurality of images 410 may include at least one non-keyframe image. In certain implementations, the three-dimensional position information may be generated for all images of the first plurality of images 410. In certain implementations, the three-dimensional position information may include position information for key points of the vehicle, such as position information for key points that are visible within the images, not visible within the images, or combinations thereof. In certain implementations, the three-dimensional position information may be used as ground truth during training of the first machine learning model 418. For example, the model 418 may be trained based on training data to perform one or more vehicular functions (such as to identify positions of nearby vehicles). In such instances, the corrected three-dimensional position information for the vehicle may be added to training data for the model 418 (such as in association with corresponding keyframes). As one example, the training data sets may specify one or more expected outputs, and the three-dimensional position information may represent expected outputs for the corresponding images. In certain implementations, additional information may be used during training, such as one or more of the key point locations, the pose estimations, and the three-dimensional contours.

Parameters of the model 418 may be updated based on whether the model 418 generates correct outputs when compared to the expected outputs. In particular, the model 418 may receive one or more pieces of input data from the training data sets that are associated with a plurality of expected outputs. The model 418 may generate predicted outputs based on a current configuration of the model 418. The predicted outputs may be compared to the expected outputs and one or more parameter updates may be computed based on differences between the predicted outputs and the expected outputs. In particular, the parameters may include weights (e.g., priorities) for different features and combinations of features. The parameter updates to the model 418 may include updating one or more of the features analyzed and/or the weights assigned to different features or combinations of features (e.g., relative to the current configuration of the model 418).

As explained above, the computing device may include or otherwise implement one or more machine learning models 414, 416, 418. In various implementations, the models 414, 416, 418 may be implemented as one or more machine learning models, including supervised learning models, unsupervised learning models, other types of machine learning models, and/or other types of predictive models. For example, the models 414, 416, 418 may be implemented as one or more of a neural network, a transformer model, a decision tree model, a support vector machine, a Bayesian network, a classifier model, a regression model, and the like.

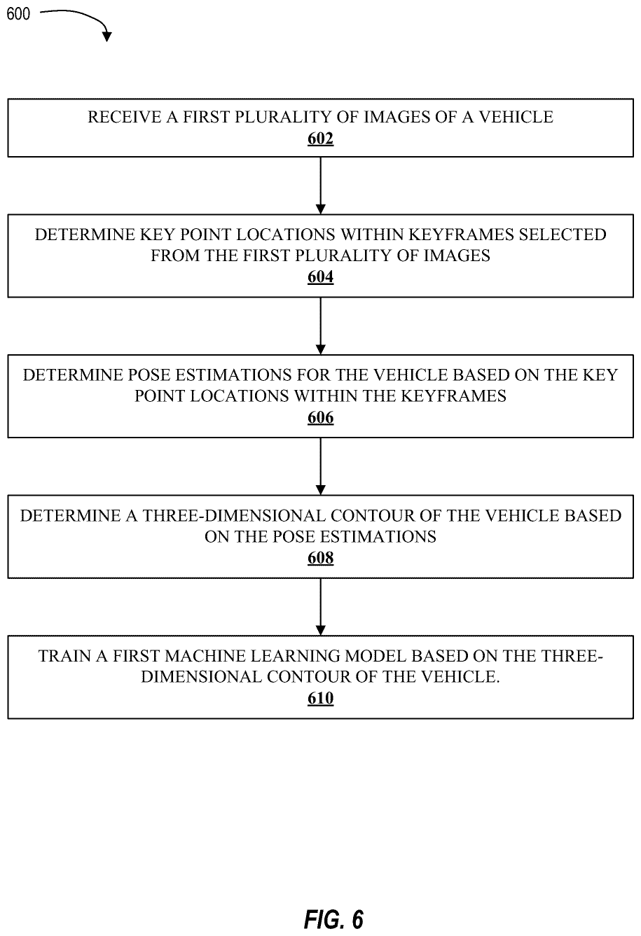

One method of performing image processing according to embodiments described above is shown in FIG. 6. FIG. 6 is a flow chart illustrating an example method 600 for vehicle shape and pose determination. The method may be performed by one or more of the above systems, such as the systems 100, 200, 300, 400.

The method 600 includes receiving a first plurality of images of a vehicle (block 602). For example, the computing device 402 may receive a first plurality of images 410 of a vehicle. In certain implementations, the plurality of images of the vehicle include multiple views of the vehicle captured from multiple angles. In certain implementations, at least a subset of the multiple views are captured at different times by a first camera. In certain implementations, the plurality of images are a sequence of images captured by one or more cameras 404, 406, 408. In certain implementations, the first plurality of images 410 of a vehicle are selected based on a cross-correlation of a second plurality of images captured by the cameras 404, 406, 408 to identify the first plurality of images 410 that contain depictions of the vehicle.

The method 600 includes determining key point locations within keyframes selected from the first plurality of images (block 604). For example, the computing device 402 may determine key point locations 428 within keyframes 412 selected from the first plurality of images 410. In certain implementations, further comprising, prior to determining the key point locations 428, determining the keyframes 412 as a subset of the first plurality of images 410 of the vehicle. The keyframes 412 may be identified based on positions of the vehicle within the subset of the first plurality of images 410. In certain implementations, the keyframes 412 may be identified as images from the first plurality of images 410 in which the vehicle may be located within a center portion. In certain implementations, the predefined vehicle features include one or more spatial features representative of a particular object or portion of the vehicle. In certain implementations, the key point locations 428 are determined as a vector perpendicular to the surface of the vehicle at the locations 428 of the predefined vehicle features. In certain implementations, the key points may in this way approximate or otherwise define a three-dimensional contour with greater detail than a bounding box. In certain implementations, the key point locations 428 are determined using a machine learning model 414.

The method 600 includes determining pose estimations for the vehicle based on the key point locations within the keyframes (block 606). For example, the computing device 402 may determine pose estimations 420 for the vehicle based on the key point locations 428 within the keyframes 412. In certain implementations, the pose estimations 420 may reflect an estimated shape and orientation of the vehicle relative to a camera that captured the keyframe. In certain implementations, the pose estimations 420 may be determined by connecting the key points to form an approximated shape of the vehicle.

The method 600 includes determining a three-dimensional contour of the vehicle based on the pose estimations (block 608). For example, the computing device 402 may determine a three-dimensional contour 422 of the vehicle based on the pose estimations 420. In certain implementations, the three-dimensional contour 422 of the vehicle may be determined as a weighted combination of vehicle shape base vectors. In certain implementations, the three-dimensional contour 422 of the vehicle may be determined according to an active shape model (ASM). In certain implementations, weights corresponding to the base vectors may be determined according to one or more cost functions. In certain implementations, the weights are determined to minimize reprojection errors between the keyframes and reprojected key points generated based on the three-dimensional contour 422. In certain implementations, the weights are determined to minimize positional differences between key points and positional measurements corresponding to the keyframes. In certain implementations, weights may be determined based on multiple cost functions (such as according to a weighted combination of multiple cost functions). In certain implementations, the method 600 further includes prior to determining the pose estimations 420 receiving, via a user-interface, one or more corrected key point locations 428 and determining the pose estimations 420 based on the corrected key point locations 428.

The method 600 includes training a first machine learning model based on the three-dimensional contour of the vehicle (block 610). For example, the computing device 402 may train a first machine learning model 418 based on the three-dimensional contour 422 of the vehicle. In certain implementations, the method 600 further includes, prior to training the first machine learning model 418, determining three-dimensional time-series data 424 comprising three-dimensional position information for the vehicle within at least a subset of the first plurality of images 410 of the vehicle. In such instances, training the first machine learning model 418 may include training the first machine learning model 418 based on the three-dimensional position information within at least the subset of the first plurality of images 410. In certain implementations, at least the subset the first plurality of images 410 may include at least one non-keyframe image. In certain implementations, the three-dimensional position information may be generated for all images of the first plurality of images 410. In certain implementations, the three-dimensional position information may include position information for key points of the vehicle.

In various implementations, the model 418 may be trained to determine one or more types of vehicle control instructions. In certain implementations, vehicle control instructions may refer to the set of commands and guidelines that directly or indirectly regulate the movement of a vehicle. These instructions may come in the form of direct vehicular control instructions, such as steering, braking, accelerating or combinations thereof. In additional or alternative implementations, vehicle control instructions may be supplementary instructions that support driver assistance programs, such as obstacle avoidance, blind spot monitoring, and other driver assistance alerts. control instructions may accordingly help drivers to maintain safe operation of vehicles while driving on roads and highways.

It is noted that one or more blocks (or operations) described with reference to FIG. 5 may be combined with one or more blocks (or operations) described with reference to another of the figures. For example, one or more blocks (or operations) of FIG. 5 may be combined with one or more blocks (or operations) of FIG. 1-3. As another example, one or more blocks associated with FIG. 5 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. A first aspect includes a method that includes receiving a first plurality of images of a vehicle. The method also includes determining key point locations within keyframes selected from the first plurality of images. The method also includes determining pose estimations for the vehicle based on the key point locations within the keyframes. The method also includes determining a three-dimensional contour of the vehicle based on the pose estimations. The method also includes training a first machine learning model based on the three-dimensional contour of the vehicle.

In a second aspect, in combination with the first aspect, the method includes, prior to determining the key point locations, determining the keyframes as a subset of the first plurality of images of the vehicle, where the keyframes are identified based on positions of the vehicle within the subset of the first plurality of images.

In a third aspect, in combination with the second aspect, the keyframes are identified as images from the first plurality of images in which the vehicle is located within a center portion.

In a fourth aspect, in combination with one or more of the first aspect through the third aspect, the key point locations are locations of predefined vehicle features within the keyframes.

In a fifth aspect, in combination with the fourth aspect, the key point locations are determined as a vector perpendicular to a surface of the vehicle at the locations of the predefined vehicle features.

In a sixth aspect, in combination with one or more of the first aspect through the fifth aspect, the key point locations are determined using a second machine learning model.

In a seventh aspect, in combination with one or more of the first aspect through the sixth aspect, each respective pose estimation of the pose estimations reflects an estimated shape and orientation of the vehicle relative to a camera that captured a corresponding respective keyframe of the keyframes.

In an eighth aspect, in combination with one or more of the first aspect through the seventh aspect, the three-dimensional contour of the vehicle is determined as a weighted combination of vehicle shape base vectors.

In a ninth aspect, in combination with the eighth aspect, weights corresponding to the vehicle shape base vectors are determined to minimize reprojection errors between the keyframes and reprojected key points generated based on the three-dimensional contour.

In a tenth aspect, in combination with one or more of the eighth aspect through the ninth aspect, weights corresponding to the vehicle shape base vectors are determined to minimize differences between key points and positional measurements corresponding to the keyframes.

In an eleventh aspect, in combination with one or more of the first aspect through the tenth aspect, training the first machine learning model includes training the first machine learning model based on the three-dimensional position information within at least the subset of the first plurality of images.

In a twelfth aspect, in combination with the eleventh aspect, the three-dimensional position information is used as ground truth during training of the first machine learning model.

In a thirteenth aspect, in combination with one or more of the first aspect through the twelfth aspect, the first machine learning model is trained to determine vehicle control instructions.

A fourteenth aspect includes an apparatus that a memory storing processor-readable code and at least one processor coupled to the memory. The at least one processor may be configured to execute the processor-readable code to cause the at least one processor to perform operations that include receiving a first plurality of images of a vehicle. The operations also include determining key point locations within keyframes selected from the first plurality of images. The operations also include determining pose estimations for the vehicle based on the key point locations within the keyframes. The operations also include determining a three-dimensional contour of the vehicle based on the pose estimations. The operations also include training a first machine learning model based on the three-dimensional contour of the vehicle. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a fifteenth aspect, in combination with the fourteenth aspect, the operations further include, prior to determining the key point locations, determining the keyframes as a subset of the first plurality of images of the vehicle, where the keyframes are identified based on positions of the vehicle within the subset of the first plurality of images.

In a sixteenth aspect, in combination with the fifteenth aspect, the keyframes are identified as images from the first plurality of images in which the vehicle is located within a center portion.

In a seventeenth aspect, in combination with the fourteenth aspect, the key point locations are locations of predefined vehicle features within the keyframes.

In an eighteenth aspect, in combination with the seventeenth aspect, the key point locations are determined as a vector perpendicular to a surface of the vehicle at the locations of the predefined vehicle features.

In a nineteenth aspect, in combination with one or more of the fourteenth aspect through the eighteenth aspect, the three-dimensional contour of the vehicle is determined as a weighted combination of vehicle shape base vectors.

In a twentieth aspect, in combination with the nineteenth aspect, weights corresponding to the vehicle shape base vectors are determined to minimize reprojection errors between the keyframes and reprojected key points generated based on the three-dimensional contour.

In a twenty-first aspect, in combination with one or more of the nineteenth aspect through the twentieth aspect, weights corresponding to the vehicle shape base vectors are determined to minimize differences between key points and positional measurements corresponding to the keyframes.

In a twenty-second aspect, in combination with one or more of the fourteenth aspect through the twenty-first aspect, the operations further comprise, prior to training the first machine learning model, determining three-dimensional time-series data comprising three-dimensional position information for the vehicle within at least a subset of the first plurality of images of the vehicle, and training the first machine learning model includes training the first machine learning model based on the three-dimensional position information within at least the subset of the first plurality of images.

A twenty-third aspect includes a non-transitory computer-readable medium storing instructions that, when executed by a processor, cause the processor to perform operations that include receiving a first plurality of images of a vehicle. The operations also include determining key point locations within keyframes selected from the first plurality of images. The operations also include determining pose estimations for the vehicle based on the key point locations within the keyframes. The operations also include determining a three-dimensional contour of the vehicle based on the pose estimations. The operations also include training a first machine learning model based on the three-dimensional contour of the vehicle.

In a twenty-fourth aspect, in combination with the twenty-third aspect, the operations further include, prior to determining the key point locations, determining the keyframes as a subset of the first plurality of images of the vehicle, where the keyframes are identified based on positions of the vehicle within the subset of the first plurality of images.

In a twenty-fifth aspect, in combination with one or more of the twenty-third aspect through the twenty-fourth aspect, the three-dimensional contour of the vehicle is determined as a weighted combination of vehicle shape base vectors.

In a twenty-sixth aspect, in combination with one or more of the twenty-third aspect through the twenty-fifth aspect, the operations further include, prior to training the first machine learning model, determining three-dimensional time-series data may include three-dimensional position information for the vehicle within at least a subset of the first plurality of images of the vehicle, and training the first machine learning model includes training the first machine learning model based on the three-dimensional position information within at least the subset of the first plurality of images.

A twenty-seventh aspect includes a vehicle that includes a memory storing processor-readable code and at least one processor coupled to the memory. The at least one processor may be configured to execute the processor-readable code to cause the at least one processor to perform operations that include receiving a first plurality of images of a vehicle. The operations also include determining key point locations within keyframes selected from the first plurality of images. The operations also include determining pose estimations for the vehicle based on the key point locations within the keyframes. The operations also include determining a three-dimensional contour of the vehicle based on the pose estimations. The operations also include training a first machine learning model based on the three-dimensional contour of the vehicle.

In a twenty-eighth aspect, in combination with the twenty-seventh aspect, the operations further include, prior to determining the key point locations, determining the keyframes as a subset of the first plurality of images of the vehicle, where the keyframes are identified based on positions of the vehicle within the subset of the first plurality of images.

In a twenty-ninth aspect, in combination with one or more of the twenty-seventh aspect through the twenty-eighth aspect, the three-dimensional contour of the vehicle is determined as a weighted combination of vehicle shape base vectors.

In a thirtieth aspect, in combination with one or more of the twenty-seventh aspect through the twenty-ninth aspect, the operations further include, prior to training the first machine learning model, determining three-dimensional time-series data may include three-dimensional position information for the vehicle within at least a subset of the first plurality of images of the vehicle, and training the first machine learning model includes training the first machine learning model based on the three-dimensional position information within at least the subset of the first plurality of images.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
receiving a first plurality of images of a vehicle;
determining key point locations within keyframes selected from the first plurality of images;
determining pose estimations for the vehicle based on the key point locations within the keyframes;
determining a three-dimensional contour of the vehicle based on the pose estimations; and
training a first machine learning model based on the three-dimensional contour of the vehicle.

2. The method of claim 1, further comprising, prior to determining the key point locations, determining the keyframes as a subset of the first plurality of images of the vehicle, wherein the keyframes are identified based on positions of the vehicle within the subset of the first plurality of images.

3. The method of claim 2, wherein the keyframes are identified as images from the first plurality of images in which the vehicle is located within a center portion.

4. The method of claim 1, wherein the key point locations are locations of predefined vehicle features within the keyframes.

5. The method of claim 4, wherein the key point locations are determined as a vector perpendicular to a surface of the vehicle at the locations of the predefined vehicle features.

6. The method of claim 1, wherein the key point locations are determined using a second machine learning model.

7. The method of claim 1, wherein each respective pose estimation of the pose estimations reflects an estimated shape and orientation of the vehicle relative to a camera that captured a corresponding respective keyframe of the keyframes.

8. The method of claim 1, wherein the three-dimensional contour of the vehicle is determined as a weighted combination of vehicle shape base vectors.

9. The method of claim 8, wherein weights corresponding to the vehicle shape base vectors are determined to minimize reprojection errors between the keyframes and reprojected key points generated based on the three-dimensional contour.

10. The method of claim 8, wherein weights corresponding to the vehicle shape base vectors are determined to minimize differences between key points and positional measurements corresponding to the keyframes.

11. The method of claim 1, further comprising, prior to training the first machine learning model, determining three-dimensional time-series data comprising three-dimensional position information for the vehicle within at least a subset of the first plurality of images of the vehicle, and
wherein training the first machine learning model includes training the first machine learning model based on the three-dimensional position information within at least the subset of the first plurality of images.

12. The method of claim 11, wherein the three-dimensional position information is used as ground truth during training of the first machine learning model.

13. The method of claim 1, wherein the first machine learning model is trained to determine vehicle control instructions.

14. An apparatus, comprising:
a memory storing processor-readable code; and
at least one processor coupled to the memory, the at least one processor configured to execute the processor-readable code to cause the at least one processor to perform operations including:
receiving a first plurality of images of a vehicle;
determining key point locations within keyframes selected from the first plurality of images;
determining pose estimations for the vehicle based on the key point locations within the keyframes;
determining a three-dimensional contour of the vehicle based on the pose estimations; and
training a first machine learning model based on the three-dimensional contour of the vehicle.

15. The apparatus of claim 14, wherein the operations further comprise, prior to determining the key point locations, determining the keyframes as a subset of the first plurality of images of the vehicle, wherein the keyframes are identified based on positions of the vehicle within the subset of the first plurality of images.

16. The apparatus of claim 15, wherein the keyframes are identified as images from the first plurality of images in which the vehicle is located within a center portion.

17. The apparatus of claim 14, wherein the key point locations are locations of predefined vehicle features within the keyframes.

18. The apparatus of claim 17, wherein the key point locations are determined as a vector perpendicular to a surface of the vehicle at the locations of the predefined vehicle features.

19. The apparatus of claim 14, wherein the three-dimensional contour of the vehicle is determined as a weighted combination of vehicle shape base vectors.

20. The apparatus of claim 19, wherein weights corresponding to the vehicle shape base vectors are determined to minimize reprojection errors between the keyframes and reprojected key points generated based on the three-dimensional contour.

21. The apparatus of claim 19, wherein weights corresponding to the vehicle shape base vectors are determined to minimize differences between key points and positional measurements corresponding to the keyframes.

22. The apparatus of claim 14, wherein the operations further comprise, prior to training the first machine learning model, determining three-dimensional time-series data comprising three-dimensional position information for the vehicle within at least a subset of the first plurality of images of the vehicle, and
wherein training the first machine learning model includes training the first machine learning model based on the three-dimensional position information within at least the subset of the first plurality of images.

23. A non-transitory computer-readable medium storing instructions that, when executed by a processor, cause the processor to perform operations comprising:
receiving a first plurality of images of a vehicle;
determining key point locations within keyframes selected from the first plurality of images;
determining pose estimations for the vehicle based on the key point locations within the keyframes;
determining a three-dimensional contour of the vehicle based on the pose estimations; and
training a first machine learning model based on the three-dimensional contour of the vehicle.

24. The non-transitory computer-readable medium of claim 23, wherein the operations further comprise, prior to determining the key point locations, determining the keyframes as a subset of the first plurality of images of the vehicle, wherein the keyframes are identified based on positions of the vehicle within the subset of the first plurality of images.

25. The non-transitory computer-readable medium of claim 23, wherein the three-dimensional contour of the vehicle is determined as a weighted combination of vehicle shape base vectors.

26. The non-transitory computer-readable medium vehicle of claim 23, wherein the operations further comprise, prior to training the first machine learning model, determining three-dimensional time-series data comprising three-dimensional position information for the vehicle within at least a subset of the first plurality of images of the vehicle, and
wherein training the first machine learning model includes training the first machine learning model based on the three-dimensional position information within at least the subset of the first plurality of images.

27. A vehicle, comprising:
a memory storing processor-readable code; and
at least one processor coupled to the memory, the at least one processor configured to execute the processor-readable code to cause the at least one processor to perform operations including:
receiving a first plurality of images of a vehicle;
determining key point locations within keyframes selected from the first plurality of images;
determining pose estimations for the vehicle based on the key point locations within the keyframes;
determining a three-dimensional contour of the vehicle based on the pose estimations; and
training a first machine learning model based on the three-dimensional contour of the vehicle.

28. The vehicle of claim 27, wherein the operations further comprise, prior to determining the key point locations, determining the keyframes as a subset of the first plurality of images of the vehicle, wherein the keyframes are identified based on positions of the vehicle within the subset of the first plurality of images.

29. The vehicle of claim 27, wherein the three-dimensional contour of the vehicle is determined as a weighted combination of vehicle shape base vectors.

30. The vehicle of claim 27, wherein the operations further comprise, prior to training the first machine learning model, determining three-dimensional time-series data comprising three-dimensional position information for the vehicle within at least a subset of the first plurality of images of the vehicle, and
wherein training the first machine learning model includes training the first machine learning model based on the three-dimensional position information within at least the subset of the first plurality of images.
